(19) United States
(12) Patent Application Publication
(10) Pub. No.: US 2024/0307899 A1
(43) Pub. Date: Sep. 19, 2024

(54) DIRECTIONAL WATER NOZZLE VIA FLOW CONTROL OF IMPINGING JETS

(71) Applicant: KOHLER MIRA LIMITED, Cheltenham (GB)

(72) Inventors: Robin Whitfield, Cheltenham (GB); Craig Fitton, Cheltenham (GB); Samuel Mason, Cheltenham (GB)

(21) Appl. No.: 18/597,751

(22) Filed: Mar. 6, 2024

Related U.S. Application Data
(60) Provisional application No. 63/490,901, filed on Mar. 17, 2023.
(60) Provisional application No. 63/559,360, filed on Feb. 29, 2024.

(51) Int. Cl. B05B 1/26; B05B 1/16; B05B 1/18

(52) U.S. Cl. CPC B05B 1/26; B05B 1/16; B05B 1/185

(57) ABSTRACT

A showerhead is provided that may include a plurality of nozzle systems (each nozzle system including a first channel and a second channel) and a first and second fluid path. The showerhead may include a first valve which may control a first flow rate of fluid flowing through the first fluid path and a second valve which may control a second flow rate of fluid flowing through the second fluid path. The showerhead may include at least one controller which may control the first and second valves. The first and second channels may be angled such that fluid exiting the first channel impinges on fluid exiting the second channel.

### CROSS-REFERENCE TO RELATED APPLICATIONS

The present application claims priority to U.S. Provisional Patent Application No. 63/490,901, filed Mar. 17, 2023, entitled, “DIRECTIONAL WATER NOZZLE VIA FLOW CONTROL OF IMPINGING JETS,” and U.S. Provisional Patent Application No. 63/559,360, filed Feb. 29, 2024, entitled, “ORGANIC NOZZLE,” the entire contents of which are hereby incorporated by reference.

### BACKGROUND

Flow control and temperature control of water are important in the bathing industry. Users tend to prefer showerheads, faucets, and nozzles that include various modes that provide different flow streams. However, the flow rate of water can impact its temperature, and the ability to adjust flow patterns of water can implicate additional hardware.

A shower system may include modes such as a rain mode and a burst mode. To achieve the differing modes, the shower system may be configured to alter the flow rate of the water. Each of the modes may present differing resistance to the flow of water. For example, the rain mode may present the least resistance to the flow of water, while the burst mode may present the greatest resistance to the flow of water. The flow rate of the water in the burst mode may therefore be lower than the flow rate of the water in the rain mode. This variable flow rate may lead to unintended consequences, particularly when a user switches between a low-pressure mode and a high-pressure mode. If a user switches from the rain mode to the burst mode during use with some flow-sensitive showers, such as electric showers, the temperature of the water may undesirably rise. If a user switches from the burst mode to the rain mode during use, the temperature of the water may undesirably drop.

### BRIEF DESCRIPTION OF DRAWINGS

FIG. 1 is a perspective view of an example first spray pattern exiting an example sprayplate.

FIG. 2 is a perspective view of an example second spray pattern exiting an example showerhead.

FIG. 3 is a perspective view of an example third spray pattern exiting the example sprayplate.

FIG. 4 is a first perspective view of an example nozzle system.

FIG. 5 is a second perspective view of the example nozzle system.

FIG. 6 is a third perspective view of the example nozzle system.

FIG. 7 is a first perspective view of an example shower system.

FIG. 8 is an enlarged perspective view of the example nozzle system of the example shower system according to FIG. 7.

FIG. 9 is an expanded perspective view of the example showerhead.

FIG. 10 is a top view of an example third layer of the example showerhead.

FIG. 11 is a schematic view of an example shower system.

FIG. 12 is a schematic view of an example shower system.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

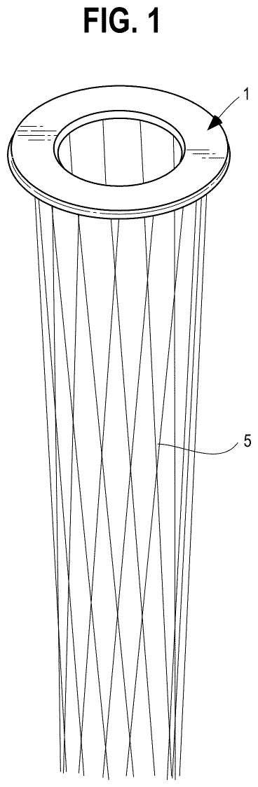

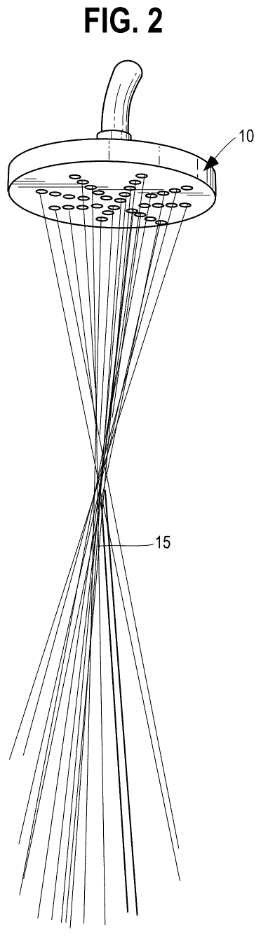

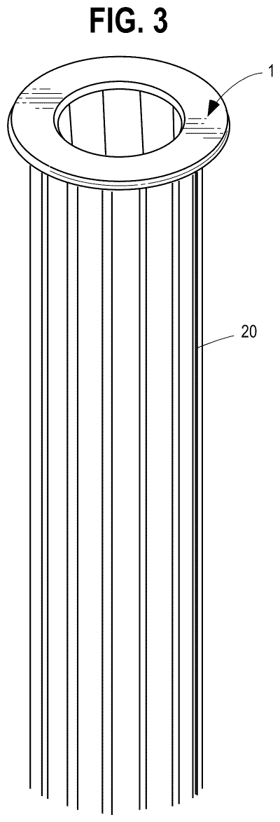

Turning first to FIG. 1, a sprayplate 1 may be configured to spray a first spray pattern 5. Each of the water streams in the first spray pattern 5 may be directed at one or more angles that do not coincide with each other. The water streams may also be directed at one or more angles such that they intersect with other water streams to form a unique spray pattern. For example, as illustrated in FIG. 2, all water streams from a showerhead 10 may form a second spray pattern 15 by intersecting at the same single location, creating an intense spray of water at that location. Alternatively, the individual water streams may not intersect with one another. In FIG. 3, the sprayplate 1 may be configured to spray a third spray pattern 20 in which none of the water streams are emitted at an angle such that the third spray pattern 20 takes the form of a standard “rain” mode.

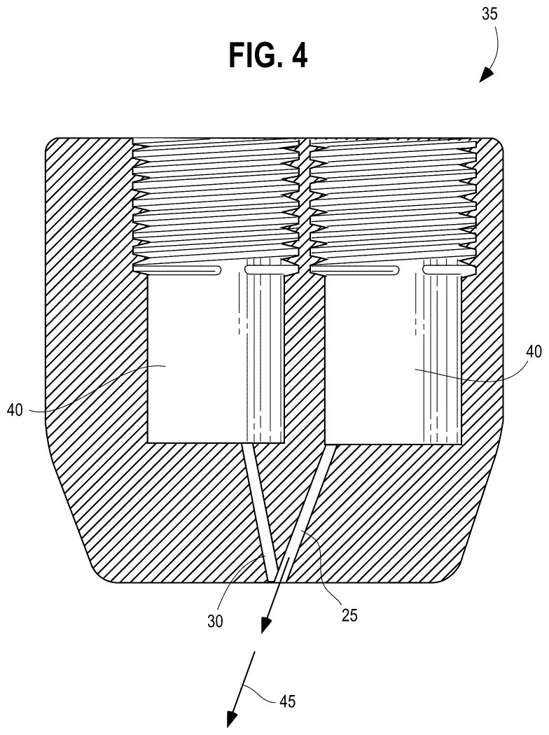

Different spray patterns may be achieved without any physical rotation or movement of any water outlets. Rather than a standard water outlet or water nozzle, FIG. 4 illustrates that there is at least a first channel 25 and a second channel 30 in each nozzle system 35. Each nozzle system 35 may include any number of channels. Each of the channels may carry any fluid (e.g., water, shampoo, other cleaners, etc.). As an example, each nozzle system 35 may include two channels (as set forth in FIG. 4); as another example, each nozzle system 35 may include five or more channels. A nozzle system 35 may be positioned in the sprayplate 1 or showerhead 10 at one or more locations at which a normal water outlet/water nozzle would be located on a standard showerhead. The first and second channels 25, 30 may be connected to respective water inputs 40 that feed water into the first and second channels 25, 30. As shown in FIG. 4, the water inputs 40 may be located in the nozzle system 35, but it is noted that water inputs 40 may be remote from the nozzle system 35 and corresponding sprayplate 1 or showerhead 10. In a remote construction, feed lines may extend between the water inputs 40 and the nozzle system 35. In FIG. 4, only the first channel 25 is active, while the second channel 30 is inactive. When the first channel 25 is active, the water input 40 feeding the first channel 25 may allow water to flow through the first channel 25. When only one channel is active, a water output may be angled to match the angle of the active channel, as there are no other influences on the resulting stream of water. As illustrated in FIG. 4, only the first channel 25 is active, and the first water output 45 is angled to match the angle of the first channel 25.

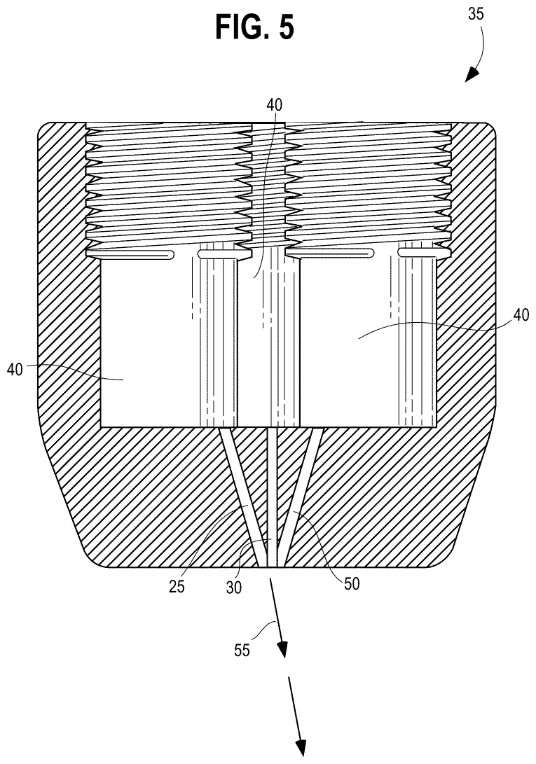

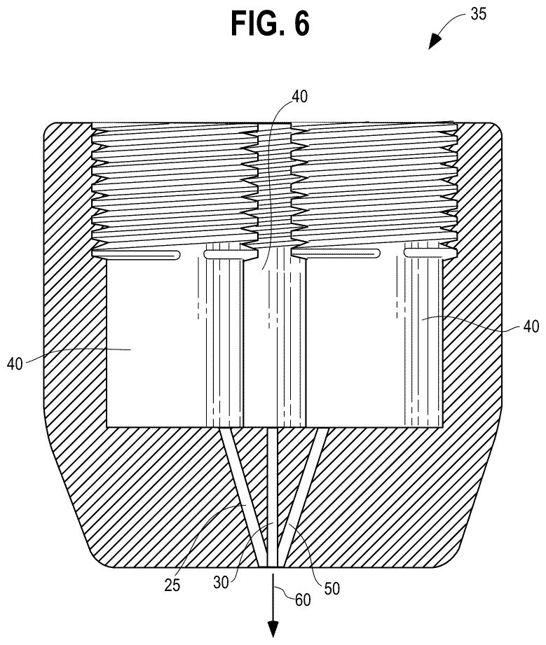

In FIGS. 5 and 6, the first and second channels 25, 30, as well as a third channel 50, are used. In FIG. 5, the first and second channels 25, 30 are active, and water may be flowing from the corresponding water inputs 40 of each of the first and second channels 25, 30. The second water output 55 may be angled in a manner that results from the incoming angle of each of the active first and second channels 25, 30. The streams of water from the first and second channels 25, 30 may impinge on one another, and the resulting second water output 55 may have an angle that is between the angles of the active first and second channels 25, 30. In FIG. 6, all three channels 25, 30, 50 are active, and water may be flowing from the corresponding water input 40 through each of the channels 25, 30, 50. The third water output 60 is therefore vertical, as the angles of each of the channels 25, 30, 50 are combined to form the angle of the third water output 60. In an example, a showerhead may include two, three, or more channels per nozzle system.

The water pressure of each channel 25, 30, 50 may vary to change the direction of the water output. Even when the water pressure of each channel 25, 30, 50 varies, the water pressure of the water output may remain the same. This may prevent the temperature of the water output from varying. For example, if all three channels 25, 30, 50 are flowing at 1 unit per minute, the resultant flow of the water output is 3 units per minute. The water output may exit at an angle calculated by the average of the angles of the channels 25, 30, 50, while accounting for the flow rate of the fluid from the channels 25, 30, 50. When the flow rates are equivalent across each channel 25, 30, 50, the water output may flow out at an angle which equals the average of the angles of the channels 25, 30, 50. To steer the water output in a different direction, for example, the first channel 25 may have a flow rate of 2 units per minute, while the second and third channels 30, 50 have a flow rate of 0.5 units per minute. The water output of the combination is maintained at 3 units per minute; however, the water output may be angled further toward the outputted angle of the first channel 25 with a flow rate of 2 units per minute. One or more valves may control the flow rates of the water flowing through the channels 25, 30, 50. In an example, the flow rate of each of the channels 25, 30, 50 may be independently controllable by a respective valve. One or more controllers may control operation of the respective valves. The one or more controllers may be any suitable controllers, including any controllers known in the art. The one or more controllers may adjust operation of the valves based on user input.

The pressure within each of the channels 25, 30, 50 may be increased beyond a certain threshold. Such threshold may be determined and/or dependent upon a specific design embodiment. When the pressure within each of the channels 25, 30, 50 is increased, the water output may have an increased velocity. The increased velocity of the water output may create a “misting” output, which may be used to create an additional user experience. Each nozzle system 35 of the showerhead 10 and/or the sprayplate 1 of the showerhead 10 may include several media exit channels, such that the showerhead 10 may eject media from each of the exit channels. In such a configuration, the media may be ejected at a lower pressure threshold, and jet-like streams may be integrated with the mist-like streams to provide a “rain-through-mist” spray mode.

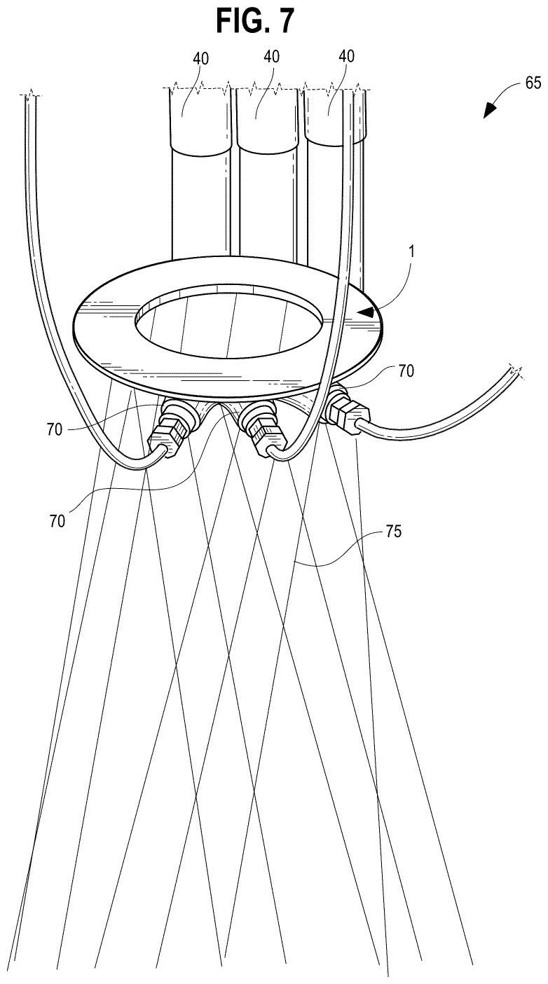

Turning now to FIG. 7, a shower system 65 may include multiple nozzle systems 35, each having three channels 25, 30, 50. Each first channel 25 in each nozzle system 35 may be connected to a first of the water inputs 40, while each second channel 30 in each nozzle system 35 may be connected to a second of the water inputs 40, and each third channel 50 in each nozzle system 35 may be connected to a third of the water inputs 40. Thus, each first channel 25 in each nozzle system 35 may be fed by the same water input 40. Similarly, each second channel 30 in each nozzle system 35 may be fed by the same water input 40, which may be different from or the same as the water input feeding the first channels 25. Likewise, each third channel 50 in each nozzle system 35 may be fed by the same water input 40, which may be different from or the same as the water input feeding the first and second channels 25, 30.

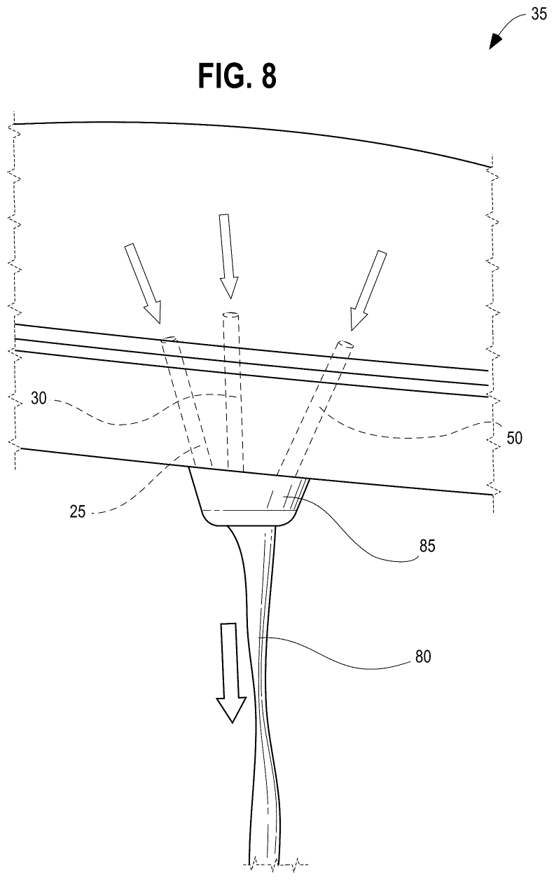

In FIG. 7, the water inputs 40 are remote from the sprayplate 1, and connect to the channels 25, 30, 50 via water feed tubes, hereinafter referred to as input lines 70. As discussed above, the nozzle system 35 may be “steerable” by altering the water pressure of the water sent from the respective water inputs 40, through the input lines 70, and to the channels 25, 30, 50 (while maintaining the overall combined water pressure) to create the water output. Allowing overall pressure changes may also be desirable in the water output. With the water inputs 40 active, a fourth spray pattern 75 may spray out of the sprayplate 1, which may be the same as or different from any of spray patterns 5, 15, or 20. The fourth spray pattern 75 may be created by plurality of fourth water outputs 80 flowing through the channels 25, 30, 50 in the configuration of FIG. 8, which illustrates an example nozzle system 35.

The nozzle system 35 may include a nozzle mouth 85. The water from each of the channels does not mix until it enters the nozzle mouth 85, which is separate from each of the channels 25, 30, 50. This “mixing in air” concept prevents water from one channel from entering the other channels, potentially leading to cross-contamination. This is particularly useful when fresh water is being supplied through one channel, for example the first channel 25, while grey water is being supplied through another channel, for example the second channel 30 or the third channel 50. Other methods of combining the water supplies may lead to contamination of the fresh water supply, as the grey water supply could potentially leak into the channel holding the fresh water.

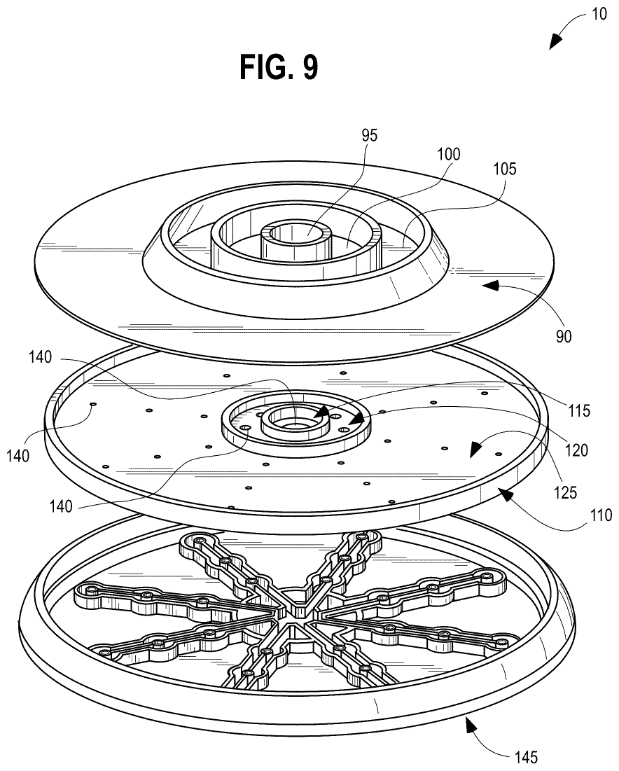

As discussed above, the shower system 65 may include a showerhead 10, which as illustrated in FIG. 9, may include several layers of varying topologies to provide all first channels 25, all second channels 30, and all third channels 50 with water from the respective same sources. A first layer 90 may include several “zones,” each of which connects to corresponding water inputs 40. The first layer 90 may include three zones: an inner zone 95; a middle zone 100; and an outer zone 105. An inner zone 95 may correspond to a first water input 40 and the first channel 25; the middle zone 100 may correspond to a second water input 40 and the second channel 30; the outer zone 105 may correspond to a third water input 40 and the third channel 50. The inner, middle, and outer zones 95, 100, 105 may be used to keep the water from each of the zones' corresponding water inputs separate from the water from the other water inputs. For example, when grey water is used, the grey water should remain separate from the water of the other water inputs to prevent possible contamination of fresh water. Each of the inner, middle, and outer zones 95, 100, 105 may include an outlet path for the water to flow into a corresponding zone of the second layer 110.

The second layer 110 may include a first zone 115, second zone 120, and third zone 125. The water from the inner zone 95 of the first layer 90 may flow into the first zone 115 of the second layer 110. The water from the middle zone 100 of the first layer 90 may flow into the second zone 120 of the second layer 110. The water from the outer zone 105 of the first layer 90 may flow into the third zone 125 of the second layer 110. Each of the first, second, and third zones 115, 120, 125 may include holes 140. The holes 140 may allow the water to pass from the second layer 110 into the third layer 145. The first zone 115 of the second layer 110 may include one singular hole 140, as it may be centrally positioned. The second zone 120 of the second layer 110 may include several holes 140 which may be evenly spaced apart from one another. The third zone 125 of the second layer 110 may include several holes 140. The holes 140 of the third zone 125 may be aligned in lines of three to match up with that of the corresponding path of a third layer 145.

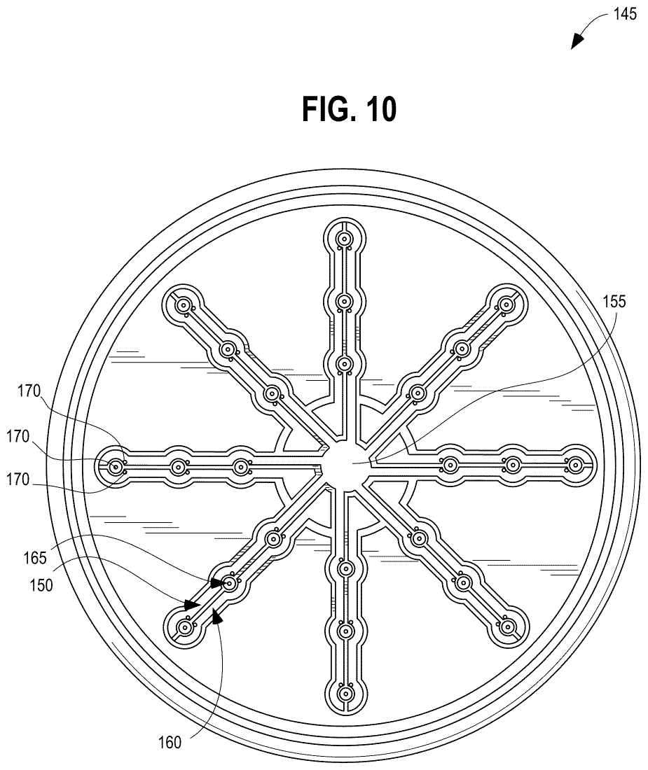

The third layer 145 may include a plurality of nozzle systems 35, and several paths for water to flow to reach the nozzle systems 35, as further illustrated in greater detail with reference to FIG. 10. A first path 150, may receive water from the first zone 115 of the second layer 110 and the inner zone 95 of the first layer 90 (ultimately from the first water input 40). As the first zone 115 from the second layer 110 includes a hole 140 at a central point 155, the first path 150 begins centrally to the third layer 145 and allows water to flow radially outwardly to the first channels 25 in the various nozzle systems 35. Although only one radially-extending first path 150 is highlighted, water may flow radially outward along the other first paths 150 as well.

A second path 160 may receive water from the second zone 120 of the second layer 110 and the middle zone 100 of the first layer 90 (ultimately from the second water input 40). As the second zone 120 of the second layer 110 includes holes 140 spaced slightly outwardly from the central point 155 of the first zone 115, the second path 160 also begins slightly outwardly from the first path 150. It similarly extends radially outwardly to the second channels 30 of the various nozzle systems 35, and again, the highlighted second path 160 may not be the only second path 160.

A third path 165 may receive water from the third zone 125 of the second layer 110 and the outer zone 105 of the first layer 90 (ultimately from the third water input 40). As the third zone 125 of the second layer 110 includes holes 140 that are positioned to correspond to the locations of the nozzle systems 35 in the third layer 145, the third paths 165 extend directly such that water flows into the third channels 50 of the nozzle systems 35 from the holes 140 in the third zone 125 of the second layer 110. Each of the paths 150, 160, 165 therefore include several outlet apertures 170, which may be nozzle systems 35, whereby the water may exit the showerhead 10.

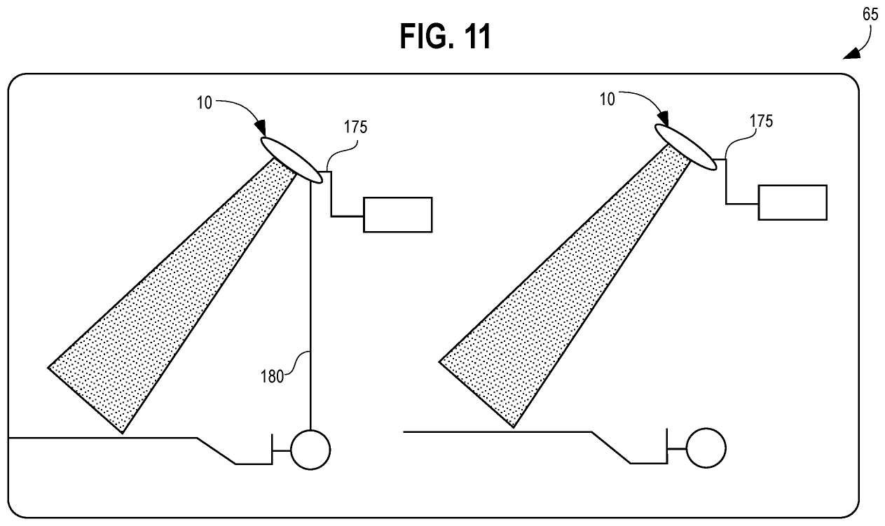

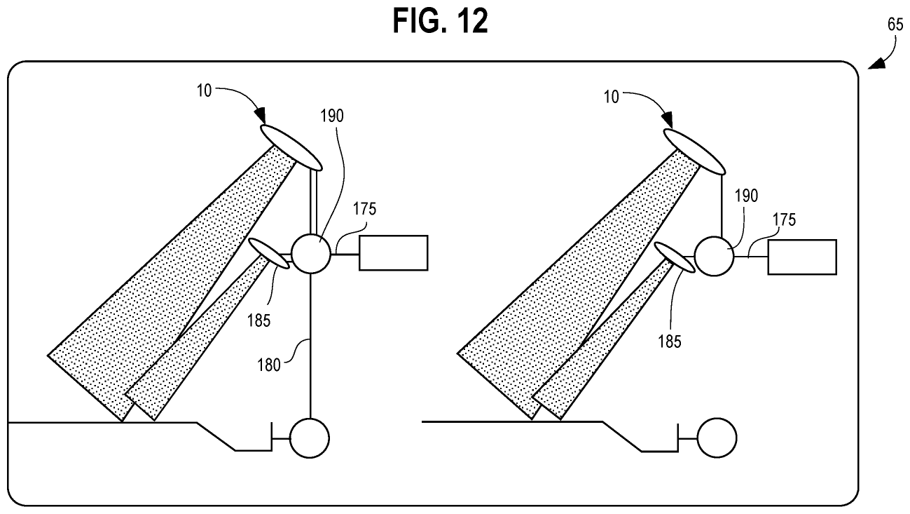

Turning to FIG. 11, the shower system 65 may include only an overhead showerhead 10. The showerhead 10 may be configured in several manners and may be connected to one water input pipe 175 or two water input pipes 175, 180. When two water input pipes 175, 180 are used, input pipe 175 may feed fresh water to the showerhead 10, while input pipe 180 may feed grey water back to the showerhead 10. Water received from input pipe 175 may therefore be routed to a different channel than the grey water from input pipe 180. In an example, grey water may be directed to the third channel 50, while fresh water may be directed to the first and second channels 25, 30. In another example, grey water may be directed to the second and third channels 30, 50, while fresh water may be directed to the first channel 25. In FIG. 12, the shower system 65 may include both an overhead showerhead 10 and a handset 185. The showerhead 10 and the handset 185 may be configured in several manners and may be connected to one water input pipe 175 or two water input pipes 175, 180. The water input pipes 175, 180 may be split via a diverter 190 before reaching the showerhead 10 and the handset 185. Water input pipe 180 may similarly be a grey water source, which is fed to a different channel than fresh water from water input pipe 175.

In an example embodiment, fluid sources other than clean water and gray water may be provided to one or more channels in one or more nozzle systems in a showerhead. For example, aromatherapy oils may be supplied to one or more channels during use, in addition to water that is supplied to other channels. In an example, three channels may be supplied with water, while three are supplied with aromatherapy oils, though other combinations are envisioned. Additionally, in an example, antibacterial cleaner may be supplied to at least one channel, to assist in cleaning of a shower stall after a user has finished showering. In such an example embodiment, three channels may be supplied with water, while a fourth is supplied with cleaner. Other fluids, and other numbers of channels may also be used.

As is evident from the foregoing description, certain aspects of the present invention are not limited by the particular details of the examples illustrated herein, and it is therefore contemplated that other modifications, applications, variations, or equivalents thereof, will occur to those skilled in the art. Many such changes, modifications, variations, and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations, and other uses and applications which do not depart from the spirit and scope of the present inventions are deemed to be covered by the inventions which are limited only by the claims which follow.

1. A showerhead comprising:
a plurality of nozzle systems, each nozzle system including at least a first channel and a second channel, wherein the first and second channels are angled such that fluid exiting the first channel impinges on fluid exiting the second channel to form a fluid output;
a first fluid path connecting the first channel of each of the plurality of nozzle systems with a first fluid input; and
a second fluid path connecting the second channel of each of the plurality of nozzle systems with a second fluid input.

2. The showerhead of claim 1, further comprising:
a first valve controlling a first flow rate of fluid flowing through the first fluid path; and
a second valve controlling a second flow rate of fluid flowing through the second fluid path.

3. The showerhead of claim 2, further comprising:
at least one controller controlling the first and second valves to determine flow rates of fluid from each of the first and second channels, wherein the first flow rate and second flow rate control a direction of a resulting stream of fluid.

4. The showerhead of claim 1, wherein each of the plurality of nozzle systems further comprise a third channel, a fourth channel, and a fifth channel.

5. The showerhead of claim 1, wherein at least one of the first channel and the second channel is active.

6. The showerhead of claim 1, wherein an angle of the fluid output is determined based on an average of an angle of the first channel and an angle of the second channel.

7. The showerhead of claim 1, wherein an angle of the fluid output is adjusted based on a first fluid pressure associated with the first channel and a second fluid pressure associated with the second channel.

8. The showerhead of claim 1, wherein each of the plurality of nozzle systems comprises a nozzle mouth, and wherein fluid passing through each of the first channel and the second channel mix after exiting the nozzle mouth.

9. A showerhead comprising:
a plurality of nozzle systems, each nozzle system including at least a first channel and a second channel, wherein the first and second channels are angled such that fluid exiting the first channel impinges on fluid exiting the second channel to form a fluid output;
a first fluid path connecting the first channel of each of the plurality of nozzle systems with a first fluid input;
a second fluid path connecting the second channel of each of the plurality of nozzle systems with a second fluid input;
a first valve controlling a first flow rate of fluid flowing through the first fluid path; and
a second valve controlling a second flow rate of fluid flowing through the second fluid path.

10. The showerhead of claim 9, further comprising:
at least one controller controlling the first and second valves to determine flow rates of fluid from each of the first and second channels, wherein the first flow rate and second flow rate control a direction of a resulting stream of fluid.

11. The showerhead of claim 9, wherein each of the plurality of nozzle systems further comprise a third channel, a fourth channel, and a fifth channel.

12. The showerhead of claim 9, wherein at least one of the first channel and the second channel is active.

13. The showerhead of claim 9, wherein an angle of the fluid output is determined based on an average of an angle of the first channel and an angle of the second channel.

14. The showerhead of claim 9, wherein an angle of the fluid output is adjusted based on a first fluid pressure associated with the first channel and a second fluid pressure associated with the second channel.

15. The showerhead of claim 9, wherein each of the plurality of nozzle systems comprises a nozzle mouth.

16. The showerhead of claim 15, wherein fluid passing through each of the first channel and the second channel mix after exiting the nozzle mouth.

17. A showerhead comprising:
a first layer comprising:
an inner zone corresponding to a first channel;
a middle zone corresponding to a second channel;
an outer zone corresponding to a third channel; and
a first, second, and third outlet path corresponding to the inner, middle, and outer zone, respectively;
a second layer comprising:
a first zone coupled to the first outlet path from the inner zone;
a second zone coupled to the second outlet path from the middle zone;
a third zone coupled to the third outlet path from the outer zone; and
a first, second, and third set of holes corresponding to the first, second, and third zone, respectively;
a third layer comprising:
a first path coupled to the first set of holes of the first zone;
a second path coupled to the second set of holes of the second zone;
a third path coupled to the third set of holes of the third zone; and
a first, second, and third set of nozzle systems corresponding to the first, second, and third path, respectively.

18. The showerhead of claim 17, wherein the first channel is connected to a first fluid input, wherein the second channel is connected to a second fluid input, and wherein the third channel is connected to a third fluid input.

19. The showerhead of claim 17, wherein, after exiting the first set of nozzle systems, fluid from the first fluid output impinges on fluid from the second and third fluid outputs after exiting the second and third sets of nozzle systems.

20. The showerhead of claim 18, further comprising:
a first valve controlling a first flow rate of fluid flowing from the first fluid input;
a second valve controlling a second flow rate of fluid flowing from the second fluid input;
a third valve controlling a third flow rate of fluid flowing from the third fluid input; and
at least one controller controlling the first, second, and third valves to determine flow rates of fluid from each of the first, second, and third fluid inputs, wherein the first flow rate, second flow rate, and third flow rate control a direction of a resulting stream of fluid.
